(19) United States
(12) Patent Application Publication
(10) Pub. No.: US 2007/0273596 A1
(43) Pub. Date: Nov. 29, 2007

(54) Antenna Apparatus Comprising a Magnetic Core

(76) Inventors: Syuuji Nakamura, Kanagawa-ken (JP); Kazuhiko Gotou, Kanagawa-ken (JP); Ryuji Minemura, Kanagawa-ken (JP); Kenji Mizushima, Kanagawa-ken (JP)

Correspondence Address: NATH & ASSOCIATES, 112 South West Street, Alexandria, VA, 22314, US

(21) Appl. No.: 10/572,752

(22) PCT Filed: Sep. 16, 2004
(86) PCT No.: PCT/JP04/13995

§ 371 Date: Mar. 21, 2006

(30) Foreign Application Priority Data
Sep. 22, 2003 (JP) 2003-329695

(51) Int. Cl. H01Q 1/32

(52) U.S. Cl. 343/711

(57) ABSTRACT

An antenna apparatus of the present invention has an antenna having a core (2) around which an insulative covered conductor (3) is wound. The core has a magnetic core (1) and a wiring layer which are laminated on each other. The magnetic core (1) is made of flexible soft magnetic material. A wiring space is formed inside of the antenna apparatus. With this structure, the packing density is enhanced.

### TECHNICAL FIELD

The present invention relates to an antenna apparatus having an antenna including a core around which an insulative covered conductor is wound.

### BACKGROUND ART

As an antenna apparatus used for a keyless entry system of an automobile, one described in Japanese Patent Application Laid-open No. 2003-224410 is known. In the conventional technique, the antenna is formed such that an insulative covered conductor is wound around a core made of ferrite or the like.

### DISCLOSURE OF INVENTION

In this conventional technique, however, when it is required to accommodate other electronic components together with the antenna apparatus in a small space, it is necessary to prepare another wiring space for supplying electricity to the electronic components or for sending or receiving signals, and there is a problem that it is difficult to downsize the apparatus.

The present invention has been achieved in order to solve the above problem, and it is therefore an object of the invention to provide an antenna apparatus capable of enhancing the packing density by forming a wiring space in the apparatus.

### BRIEF DESCRIPTION OF DRAWINGS

FIG. 1 is a sectional view of a handle apparatus in which an antenna apparatus of the present invention is disposed;

FIG. 2 is an exploded perspective view of a handle in which an antenna apparatus of the present invention is disposed; and

FIGS. 3A, 3B, 3C, and 3D show an antenna constituting the antenna apparatus of the invention, wherein FIG. 3A is a plan view of the antenna, FIG. 3B is a sectional view taken along the line 3B-3B shown in FIG. 3A, FIG. 3C is a sectional view taken along the line 3C-3C shown in FIG. 3A and shows a modification of the antenna shown in FIG. 3A, and FIG. 3D is a block diagram showing the antenna apparatus.

### BEST MODE FOR CARRYING OUT THE INVENTION

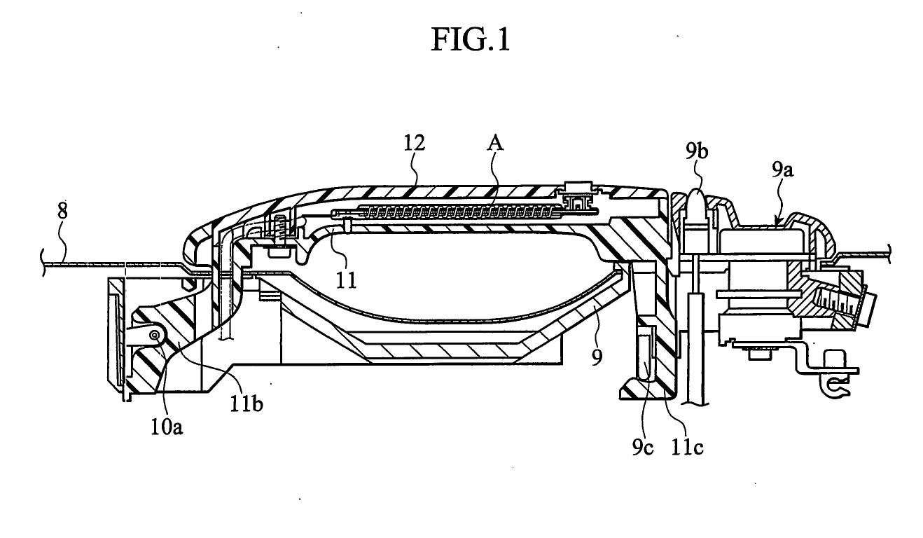

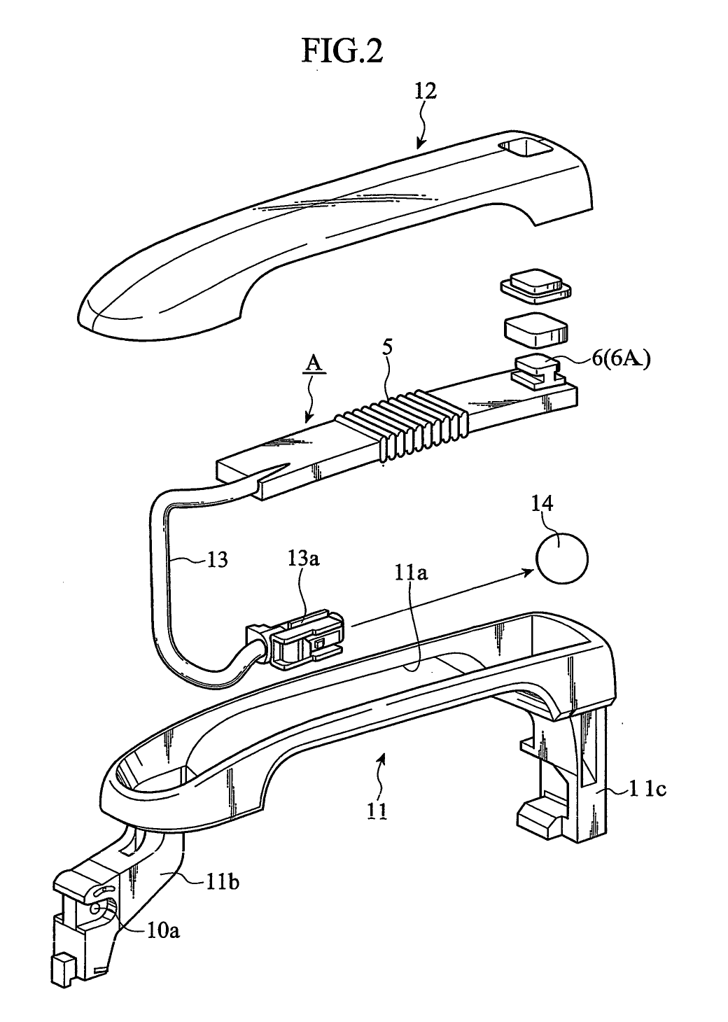

FIGS. 1 and 2 show an embodiment of the present invention. This embodiment is mounted on a door outside handle apparatus of an automobile, and is used as a constituent part of a keyless entry system. A handle apparatus comprises a handle base 9 fixed to a door panel 8 of the vehicle, and a handle 10 mounted on the handle base 9. If the handle 10 is rotated around a pivot 10a of the handle base 9, a door lock apparatus (not shown) disposed on the inner side of the door is operated.

An auxiliary lock 9a and a lock switch 9b, which can be operated by a key plate, are disposed in the handle base 9. If the auxiliary lock 9a is operated, the door lock apparatus can be opened, and if the lock switch 9b is pushed down, the door lock apparatus can be locked.

As shown in FIG. 2, the handle 10 of the handle apparatus is long in the longitudinal direction (long direction of the vehicle). The handle 10 has an antenna accommodating recess 11a formed in the body member 11. The opening of the antenna accommodating recess 11a is closed by a cover member 12. The body member 11 and the cover member 12 are made of synthetic resin. One end of the body member 11 is formed with a hinge connection portion 11b with respect to the handle base 9. The other end of the body member 11 is formed with an operation leg 11c which operates the door lock apparatus by operating an operating section 9c mounted on the handle base 9 by rotating the handle 10.

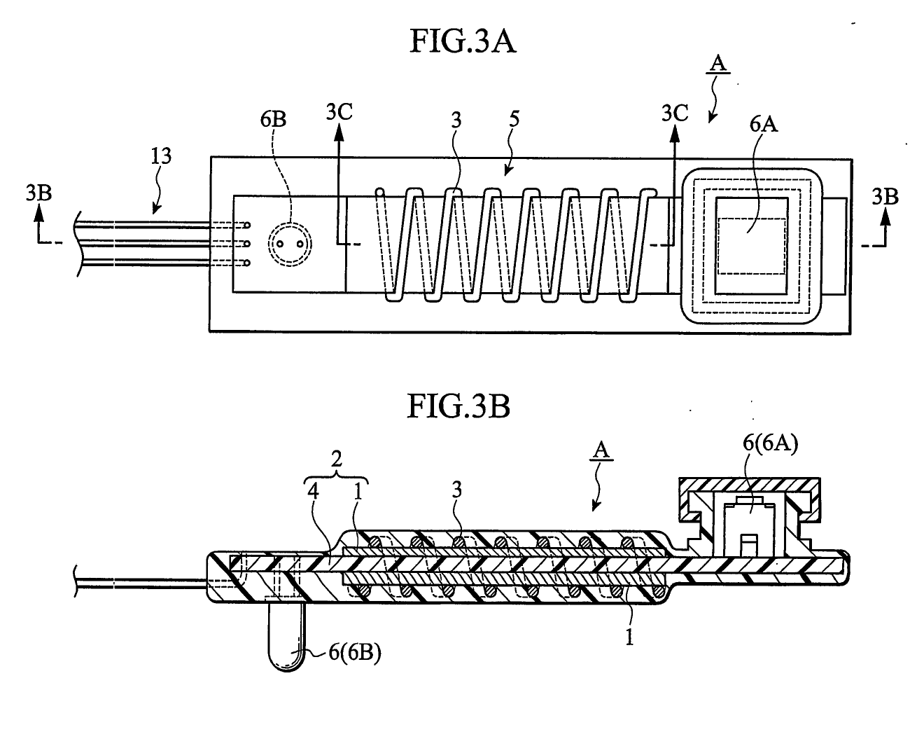

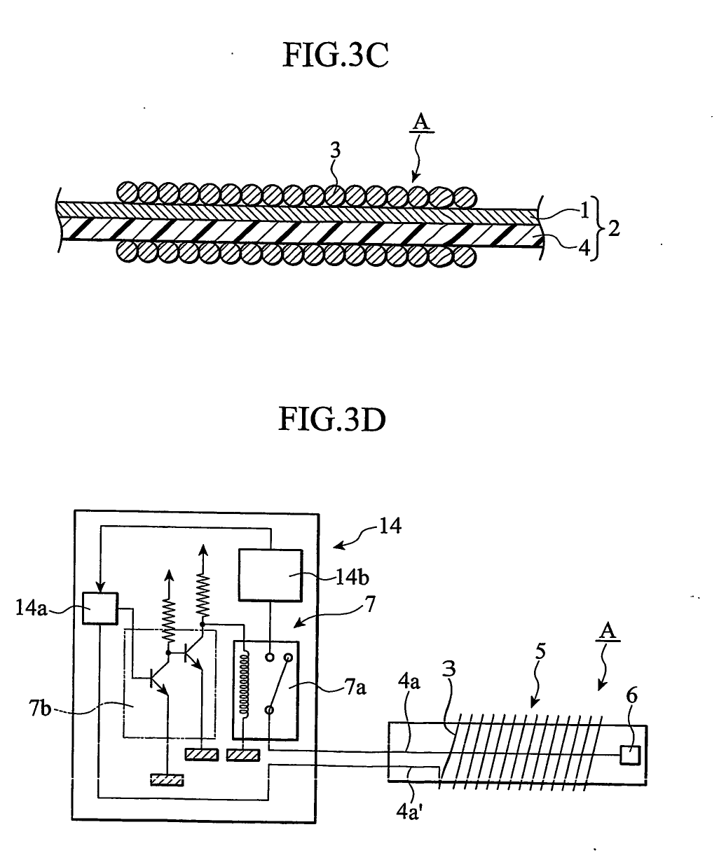

As shown in FIGS. 3A to 3D, the antenna A is accommodated in an antenna accommodating recess 11a of the body member 11. The antenna A has flexible printed wiring board (printed board 4). A magnetic core 1 is laminated on each of a front surface and a back surface of the flexible printed wiring board to form a core 2, and an insulative covered conductor 3 is wound around the core 2. The flexible printed board 4 further extends from a region where the insulative covered conductor 3 is wound around the core 2, i.e., from the coiled section 5. Both ends of the flexible printed board 4 are respectively provided with a switch (electronic component 6A) and a light-emitting diode (electronic component 6B). The coiled section 5 is located between the electronic component 6A and the electronic component 6B. It is possible to use a “BUSTERAID (tradename)” produced by NEC TOKIN Corporation as the magnetic core 1.

The flexible printed board 4 is formed with an element mounting land on which the switch 6A and the light-emitting diode 6B are to be mounted, an external connection land to which the external connection cable 13 is connected, and a pattern wire 4a which connects the element mounting land and the external connection land. The external connection land is formed with a pattern wire 4a′ for a power source for taking out electricity to be supplied to the coil and for taking out induced electromotive force at the coil. It is preferable that the power source pattern wire 4a′ is formed at a position which does not pass through the coil.

It is preferable that the pattern wires 4a and 4a′, especially the pattern wire 4a which passes through the coil is formed straightly in parallel to a center line of the coil so that linkage with respect to the magnetic flux at the coil is prevented.

The antenna A is constituted in the above-described manner. The entire antenna A is sealed with synthetic resin, and is formed as a unit. After the antenna A is assembled into the handle 10, a connector 13a provided on one end of an external connection cable 13 is connected to a controller 14 formed on the side of the vehicle in a plug-in manner.

The electronic component 6 mounted on the flexible printed board 4 is appropriately be changed by a function allocated to the handle 10 in the keyless entry system. In this embodiment, a switch 6A is controlled by the controller 14 so that the switch 6A functions as a request switch.

That is, if a user pushes down the switch 6A of the handle 10 when the user drives a vehicle, the controller 14 operates the communicating section 14a to emit communication radio wave from the antenna A to communicate with respect to the driver's portable terminal apparatus, and when the controller 14 confirms a match of the ID or the like of the portable terminal apparatus, the controller 14 unlocks the lock apparatus, and emits the light-emitting diode 6B to illuminate feet of the driver. When the driver gets off the vehicle, if the driver comes out from the vehicle and pushes down the lock switch 9b disposed on the handle base 9, the lock apparatus is locked.

The core 2 is laminated on the magnetic core 1 on the front and back surfaces of the flexible printed board 4 in the above explanation, the core 2 may be laminated on the magnetic core 1 on one surface of the flexible printed board 4 as shown in FIG. 3C.

In order to prevent the mutual influence between the coil and the pattern wire 4a on the flexible printed board 4, it is effective to provide the controller 14 with an electricity control section 7 and the antenna A and the electricity control section 7 constitute the antenna apparatus as shown in FIG. 3D. In this modification, when radio wave is sent from the antenna A, the electronic component 6 is cut away. The electricity control section 7 comprises a relay switch 7a and a relay control circuit 7b.

If a sending command is output from the controller 14 in the controller 14 to the communicating section 14a, the communicating section 14a drives the relay control circuit 7b to energize the relay switch 7a. If the relay switch 7a is energized, the pattern wire 4a with respect to the electronic component 6 is cut away from the control section 14b.

In the above explanation, the pattern wire 4a is physically or mechanically separated using the relay switch 7a. Alternatively, the relay switch 7a may be separated electrically using a switching element. In the above explanation, the pattern wire 4a is separated in synchronization with the operation of the communicating section 14a, but the separating condition and timing thereof can appropriately be changed while taking into account a condition that mutual effect between the coil and the pattern wire 4a such as electromagnetic induction, or performance of the antenna A or the control section 14b.

If the magnetic core 1 has magnetic characteristics such as magnetic permeability required as a core of the antenna, a material of the magnetic core 1 is not limited. For example, a composite magnetic material in which soft magnetic powder and organic connecting material are combined as a binder can also be used other than the soft ferrite.

Therefore, in this embodiment, since the core 2 includes the wiring layer and the antenna itself can be used as a wire element, the space can effectively be used.

The wiring layer can be formed on the printed board 4. If a flexible printed wiring board is used as the printed board 4, the wiring layer can be wound around the magnetic core 1 instead of superposing the wiring layer on the magnetic core 1. When the magnetic core 1 comprises a large number of hard magnetic materials which are connected to each other through bent joints and the magnetic core 1 has plasticity, or when a material itself of the magnetic core 1 has flexibility, if a flexible printed wiring board is used as the printed board 4, it is possible to maintain a merit obtained from the fact that the magnetic core 1 has the flexibility.

In order to reduce the interaction with respect to the coil as small as possible, it is preferable that a direct conductive wire having no waveform variation of voltage and current is used. One example thereof is a wire for supplying electricity to an illuminant (electronic component 6) such as a diode which is supplied with electricity from a battery and is lighted.

In this case, if the printed board 4 is extended from the coiled section 5 and this extended portion is provided with the electronic component 6 such as the diode, it is unnecessary to newly fix the board to another portion or to connect the other portion and the board to each other, and the assembling operation is facilitated.

In order to reduce adverse influence caused by interaction with respect to the wire at the time of tuning operation when radio wave is sent or received, if the electricity control section 7 is provided, it is possible to control the timing of excitation of the coil, energization to the wiring layer and the electrical connection.

1. An antenna apparatus comprising
an antenna having a core around which an insulative covered conductor is wound, wherein
the core comprises a magnetic core and a wiring layer which are laminated on each other, and
the magnetic core is made of flexible soft magnetic material.

2. The antenna apparatus according to claim 1, wherein the wiring layer is formed on a printed board.

3. The antenna apparatus according to claim 1, wherein
the core is provided with an extending portion which outwardly extends from a coiled section around which the insulative covered conductor is wound, and
an electronic component is mounted on the extending portion.

4. The antenna apparatus according to claim 1, further comprising an electricity control section which permits and prohibits energization to the wiring layer depending upon an operation state of the antenna.
